(19) United States
(12) Patent Application Publication
(10) Pub. No.: US 2018/0178326 A1
(43) Pub. Date: Jun. 28, 2018

(54) VACUUM SLS METHOD FOR THE ADDITIVE MANUFACTURE OF METALLIC COMPONENTS

(71) Applicant: Evobeam Gmbh, Mainz (DE)

(72) Inventors: Matthias WAHL, Darmstadt (DE); Alexander WEIL, Mainz (DE)

(73) Assignee: Evobeam Gmbh, Mainz (DE)

(21) Appl. No.: 15/736,798

(22) PCT Filed: Jul. 5, 2016
(86) PCT No.: PCT/EP2016/065755

§ 371 Date: Dec. 15, 2017

(30) Foreign Application Priority Data
Jul. 15, 2015 (DE) 10 2015 008 921.8

(51) Int. Cl. B23K 26/34; B33Y 10/00; B33Y 40/00; B23K 26/354; B23K 26/12

(52) U.S. Cl. CPC B23K 26/34; B33Y 10/00; B23K 26/123; B23K 26/354; B33Y 40/00

(57) ABSTRACT

The invention relates to a method for the additive manufacture of three-dimensional metallic components (12), these components (12) being built layer-by-layer or section-by-section under vacuum conditions using a laser (20), by fusing a metal powder with the component (12). In order to reduce production of surplus metal powder during machining, it is suggested that the metal powder is fed to and mixed with a gas stream, said gas stream being fed to the region of a machining point of the laser (20) on the surface of said component.

The present invention relates to a method for the additive manufacture of three-dimensional metallic components, wherein said components are built up in layers or sections under vacuum conditions by means of a laser by fusion of a metal powder with the component.

Such methods are known for example from EP 1 296 788 B1 or DE 10 2013 108 111 A1.

Here, the conventional approach provides that, on a substrate as a starting point for the body to be manufactured, as can furthermore also be used in this way in the present method, in the method according to the prior art a powder layer is firstly applied, which powder layer is subsequently fused, by means of a laser, to the underlying surface at those locations at which an application of material is desired. This process is repeated until the desired component has been manufactured, wherein even complex three-dimensional structures are possible by means of the layered construction.

It has however been found that, owing to the application of a further powder layer that is necessary after every layer, which further powder layer must furthermore also be spread smooth, firstly a very great expenditure of time is necessary, and secondly, relatively large quantities of powder accumulate which cannot at all be fused with the component. It is self-evident that, in the known method, the residual powder accumulates in particularly large quantities if the component to be manufactured has a relatively large number of cavities and recesses in relation to the base area.

It is the object of the present invention to improve a method of the type mentioned in the introduction such that less excess metal powder arises during the processing.

According to the invention, the object is achieved in that, in a method of the type mentioned in the introduction, the metal powder is added to a gas stream and is swirled with the latter, wherein the gas stream is supplied onto the surface of the component in the region of a processing location of the laser.

The method according to the invention has the advantage that, by means of the targeted supply with the aid of a gas stream, the metal powder is conducted exactly to that location of the component being created at which the material application is presently being performed by means of the laser. The intermediate step of firstly scattering powder over the entire workpiece surface, such as is required in the known methods, is therefore eliminated, wherein it has been found that, owing to the admixing of the metal powder to a gas stream, said metal powder can be supplied in a quantity sufficient to ensure the desired material application in the context of the additive manufacture of the component.

It is self-evident that, with the targeted supply of the metal powder only to that location of the component at which it is presently sought to apply material, the demand for supplied metal powder can be considerably reduced, because no powder whatsoever is transported to those locations at which it is not sought to apply material in the case of the layer respectively being processed. It has surprisingly been found that the losses of metal powder blown away from the processing location by the gas stream are altogether considerably less than the residues of the powder that is not to be processed in the case of a powder layer that is fused using conventional methods.

In a preferred embodiment of the invention, inert gas is suitable as a gas stream, in order to ensure that, during the fusion of the metal powder to the component, no undesired reactions occur that could impair the material quality.

In an alternative embodiment, provision may however also be made for a doped gas to be provided for the gas stream, wherein the material characteristics can be influenced in a targeted manner by means of the doped substances.

The gas stream may be conducted to the processing location in a variety of ways. For example, the gas stream with the metal powder may be supplied coaxially with respect to the laser beam direction.

In the case of the coaxial supply, a preferred embodiment may provide that the gas stream is fed in ring-shaped fashion around the laser beam.

The coaxial feed has the advantage that the metal powder directly perpendicularly strikes the processing location, such that little metal powder is scattered to the side of the processing location by the outflowing gas.

As an alternative to this, it may be provided that the gas with the metal powder is supplied laterally with respect to the laser beam direction or at an angle >0° and <90° with respect to the laser beam direction. In the case of such a supply direction, although under some circumstances the risk of non-fused powder bouncing off and being conducted laterally past the component is slightly increased, it is however the case with such an arrangement that there is slightly more space for the arrangement of the gas supply device, which may be advantageous in particular with regard to the high temperatures in the region of the processing location.

At any rate, it is preferable for the gas stream to be focused onto the processing location by means of a suitable nozzle, such that as much as possible of the metal powder that has been caused to flow in can be fused by the laser at the processing location.

In a further preferred embodiment of the invention, it is provided that the method is performed under vacuum conditions. Vacuum conditions have the advantage that there is little influence on the material characteristics, and in particular, the metal powder does not react with further substances during the application process. Performing welding processes under vacuum conditions is already known per se, such that the creation of a vacuum environment in a suitable chamber for carrying out the method according to the invention described here, which chamber is evacuated by means of a vacuum pump, does not pose any difficulties to a person skilled in the art.

In a further preferred embodiment of the invention, it is provided that the component is, during the application of material, moved under and relative to the gas stream, which is supplied by means of a static device. This has the advantage that the laser does not have to perform tracking movements, nor does the device for the supply of the gas stream laden with the metal powder.

The laser is preferably arranged outside a vacuum chamber. The laser beam is then introduced through a window into the vacuum chamber, which is evacuated by means of a vacuum pump.

In this way, the vacuum chamber itself can be kept compact, and the supply lines to the laser do not need to be led in vacuum-tight fashion into the interior of the chamber.

Two exemplary embodiments of the invention will be discussed in more detail below on the basis of the appended drawings. In the drawings:

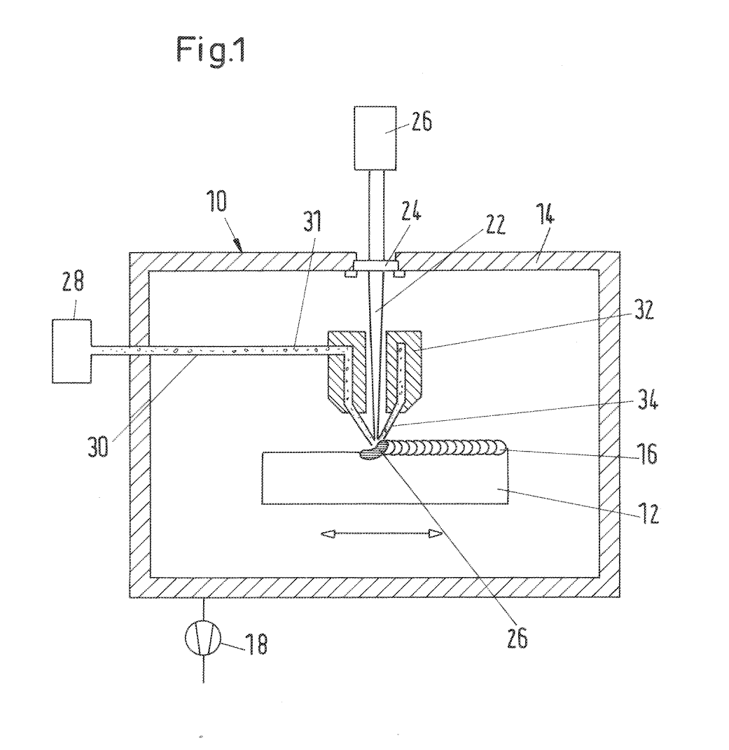

FIG. 1 shows a longitudinal section through a device for the additive manufacture of components with a coaxial supply of metal powder;

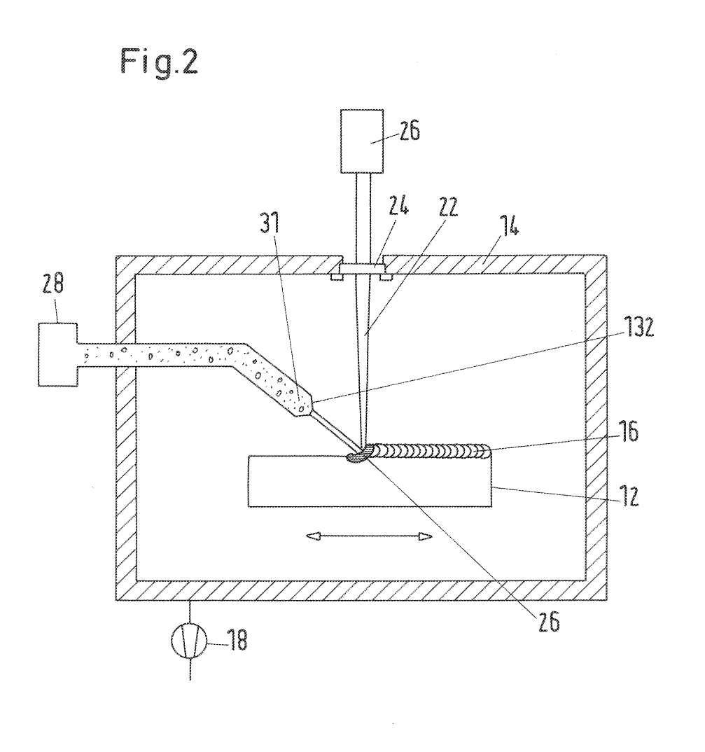

FIG. 2 shows a longitudinal section through a device similar to FIG. 1, with a supply of metal powder at an angle with respect to the laser beam;

FIG. 1 shows a device 10 with which a method for the additive manufacture of a metallic component 12 in a vacuum chamber 14 can be performed. The component 12 or workpiece is mounted on a table (not shown in any more detail) which permits a movement of the component in the x, y and z directions. The component 12 is generated in layered fashion in the context of the additive manufacture, that is to say, in the exemplary embodiment shown in FIG. 1, a series of layers has already been applied, wherein the present applied material layer 16 has, for illustrative purposes, been illustrated on an exaggeratedly large scale. The first layer may be built up on a substrate that has been introduced into the chamber 14 beforehand.

A vacuum pump 18 evacuates the interior of the vacuum chamber 14 to the pressure values that are conventional in the field of thermal processing methods in a vacuum.

The introduction of energy required for the fusion of supplied metal powder in the applied material layer 16 is provided by means of a laser 20 which is arranged outside the vacuum chamber 14. The laser beam 22 is conducted through an entrance window 24 in the wall of the vacuum chamber 14 to a processing location on the component 12, at which a melt bath 26 forms owing to the high light power of the laser 20. A device (not shown) can cause a gas to flow over the inner side of the entrance window 24, such that fouling and condensation of metal vapors at this location is prevented.

The metal powder is supplied by means of a dosing device 28 to a gas stream and is swirled with the latter. By means of a pressure-tight feed line 30, said gas stream is conducted into the interior of the vacuum chamber 14 to a ring-shaped nozzle 32, which coaxially surrounds the introduced laser beam 22. The ring-shaped nozzle 32 has a conically tapering, coaxial ring-shaped projection 34 of the nozzle, by means of which the powder-gas mixture 31 is conducted in a focused manner onto the melt bath 26. Whereas a gas in the feed stream, which may be an inert gas, which intentionally has no influence on the material application, or a doped gas, by means of which targeted changes in the material quality can be achieved, flows away laterally, the metal particles that strike the melt bath 26 immediately fuse and ensure the build-up of the applied material layer 16. During the process, the component 12 is moved in a processing direction, such that a line-by-line construction is realized. It is basically also possible for movements to be performed simultaneously in multiple corner directions, but in general, a line-by-line construction of the material will be desired. A material layer applied in this way self-evidently does not need to be continuous, but rather may be interrupted at those locations at which, owing to the construction, it is the intention for no material to be present. It is correspondingly possible during the movement of the component 12, at such locations, for the feed stream of powder-gas mixture to be changed, for the laser beam to be interrupted, and/or for the movement speed of the component 12 to be briefly greatly increased in said regions.

FIG. 2 shows a further device 110 which, in the same way as the device 10 described above, is suitable for the additive manufacture of three-dimensional metallic components 12. Most components of the device 110 shown in FIG. 2 correspond to the device described above and shown in FIG. 1, such that said components have been correspondingly denoted by identical reference designations, and will not be discussed in any more detail at this juncture with regard to their function. The difference in relation to the device 10 shown in FIG. 1 consists in that, in the device 110 as per FIG. 2, the feed of the powder-gas mixture 31 is realized via a simple nozzle 132, by means of which the powder-gas mixture is supplied to the melt bath 26 laterally at an angle. There is correspondingly a considerably simpler resulting construction of the nozzle 132, which does not need to coaxially surround the laser beam. Also, the formation of a projection in the form of a ring-shaped nozzle is not necessary here; it suffices for the nozzle to be formed, by means of a simple design of the nozzle head, such that the powder-gas mixture 31 is conducted in a focused manner into the melt bath 26. The other processes correspond to the processes discussed in conjunction with the device 10 from FIG. 1, and will not be discussed in any more detail again at this juncture.

1. A method for the additive manufacture of three-dimensional metallic components (12), wherein said components (12) are built up in layers or sections under vacuum conditions by means of a laser (20) by fusion of a metal powder with the component (12), characterized in that the metal powder is added to a gas stream and is mixed with the latter, wherein the gas stream is supplied onto the surface of the component in the region of a processing location of the laser (20).

2. The method as claimed in claim 1, characterized in that an inert gas is used as gas for the gas stream.

3. The method as claimed in claim 1, characterized in that a doped gas is used as gas for the gas stream in order to influence the material characteristics in targeted fashion by means of the doped substances.

4. The method as claimed in claim 1, characterized in that the gas with the metal powder is supplied coaxially with respect to the laser beam direction.

5. The method as claimed in claim 4, characterized in that the gas stream is supplied in ring-shaped fashion around the laser beam.

6. The method as claimed in claim 1, characterized in that the gas with the metal powder is supplied laterally with respect to the laser beam direction or at an angle >0° and <90° with respect to the laser beam direction.

7. The method as claimed in claim 1, characterized in that the gas stream is focused onto the processing location.

8. The method as claimed in claim 1, characterized in that the component (12) is, during the application of material, moved under and relative to the gas stream, which is supplied by means of a static device.

9. The method as claimed in claim 1, characterized in that the laser beam is introduced through a window (24) into a vacuum chamber (14) which is evacuated by means of a vacuum pump (18).

10. The method as claimed in claim 9, characterized in that the window is protected against sputtering and/or fouling by a gas stream.

11. The method as claimed in claim 2, characterized in that the gas with the metal powder is supplied coaxially with respect to the laser beam direction.

12. The method as claimed in claim 3, characterized in that the gas with the metal powder is supplied coaxially with respect to the laser beam direction.

13. The method as claimed in claim 11, characterized in that the gas stream is supplied in ring-shaped fashion around the laser beam.

14. The method as claimed in claim 12, characterized in that the gas stream is supplied in ring-shaped fashion around the laser beam.

15. The method as claimed in claim 2, characterized in that the gas with the metal powder is supplied laterally with respect to the laser beam direction or at an angle >0° and <90° with respect to the laser beam direction.

16. The method as claimed in claim 3, characterized in that the gas with the metal powder is supplied laterally with respect to the laser beam direction or at an angle >0° and <90° with respect to the laser beam direction.
